(19) United States
(12) Patent Application Publication
(10) Pub. No.: US 2021/0114328 A1
(43) Pub. Date: Apr. 22, 2021

(54) Corrugated Cardboard Manufacturing Brush with Acetyl Tines

(71) Applicant: Wagner Industries, Inc., Frackville, PA (US)

(72) Inventor: Stephen Wagner, Ashland, PA (US)

(21) Appl. No.: 16/654,466

(22) Filed: Oct. 16, 2019

(51) Int. Cl. B31F 1/28; A46B 9/02; B65H 9/00

(52) U.S. Cl. CPC B31F 1/2859; A46B 2200/405; B65H 9/00; A46B 9/02

(57) ABSTRACT

Embodiments related to a hold down brush with an improved tine configuration that can be used in a corrugator machine. The hold down brush can include multiple rows of tines made from acetyl, wherein the tines are embedded within a polyurethane base of the brush. The acetyl tines are food-grade and reduce or eliminate breakage. Embedding the tines (as opposed to gluing them) reduces or eliminates dislodging of the tines in operation. In addition, the hold down brush can be made into a number of small brush segments, which can facilitate quick and easy replacement and maintenance.

### FIELD OF THE INVENTION

Embodiments related to a hold down brush with an improved tine configuration that can be used in a corrugator machine.

### BACKGROUND OF THE INVENTION

Conventional hold down brushes are limited in that they use tines that are not food-grade material, the tines tend to break due to fatigue, the tines tend to dislodge from the brush, and the brushes include base portions that are too large to facilitate quick and easy replacement and maintenance.

Examples of known systems and methods related to hold down brushes can be appreciated from DE102007007993, EP0431267, JP 4410359, JPH0644675Y2, corrugatedonline.net/wp-content/uploads/2017/04/04WagnerCorrugatorBrushes2015.pdf, and www.wagnerind.com/corrugator-hold-brushes.

### SUMMARY OF THE INVENTION

Embodiments related to a hold down brush with an improved tine configuration that can be used in a corrugator machine. The hold down brush can include multiple rows of tines made from acetyl, wherein the tines are embedded within a polyurethane base of the brush. The acetyl tines are food-grade and reduce or eliminate breakage. Embedding the tines (as opposed to gluing them) reduces or eliminates dislodging of the tines in operation. In addition, the hold down brush can be made into a number of small brush segments, which can facilitate quick and easy replacement and maintenance.

In an exemplary embodiment, a hold down brush can include a base having a first side and a second side. A plurality of tines can extend from the first side, and a coupling mechanism can be disposed in or on the base at or near the second side, wherein the coupling mechanism is configured to attach the hold down brush to a support portion of a corrugator machine.

In some embodiments, the base is made from polyurethane.

In some embodiments, each tine is made from acetyl.

In some embodiments, the base is formed by a molding process and each tine is embedded in the base during the molding process.

In some embodiments, the plurality of tine includes a first row of tines and a second row of tines.

In some embodiments, the tines of the first row are not staggered with respect to the tines of the second row.

In some embodiments, the tines of the first row are staggered with respect to the tines of the second row.

In some embodiments, the base has a width that is less than a width of a conveyor of the corrugator machine.

In an exemplary embodiment, a method of using hold down brush for a corrugator machine can involve attaching a first hold down brush to a support portion of the corrugator machine. The method can further involve attaching a second hold down brush to the support portion of the corrugator machine so that the second hold down brush is adjacent the first hold down brush.

In some embodiments, the method can involve removing the first hold down brush and/or the second hold down brush for replacement or repair.

In some embodiments, the method can further involve attaching a third hold down brush to the support portion of the corrugator machine so that the third hold down brush is adjacent the second hold down brush.

In some embodiments, a distal end of the first hold down brush and a distal end of the second hold down brush have tines that overextend product being conveyed via the corrugator machine.

In some embodiments, a distal end of the first hold down brush and a distal end of the third hold down brush have tines that overextend product being conveyed via the corrugator machine.

In an exemplary embodiment, a method of making a hold down brush for a corrugator machine can involve: inserting a plurality of tines in a mold; introducing a polymer into the mold; and allowing the polymer to cure or harden to form a base and to embed the plurality of tines within the base.

In some embodiments, the plurality of tines includes a first row of tines and a second row of tines.

In some embodiments, the method can further involve staggering the tines of the first row with respect to the tines of the second row.

In some embodiments, the method can further involve aligning the tines of the first row with respect to the tines of the second row.

In some embodiments, the polymer is polyurethane.

In some embodiments, each tine is acetyl.

In some embodiments, the method can further involve disposing a coupling mechanism in or on the base.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 shows an exemplary corrugator machine within which an embodiment of the hold down brush can be used.

FIG. 2 shows an exemplary use of a hold down brush within a conveyance system of a corrugator machine.

FIG. 3 shows another exemplary use of a hold down brush within a conveyance system of a corrugator machine.

FIG. 4 shows another exemplary use of a hold down brush within a conveyance system of a corrugator machine.

FIG. 5 shows another exemplary use of a hold down brush within a conveyance system of a corrugator machine.

FIG. 6 shows another exemplary use of a hold down brush within a conveyance system of a corrugator machine.

FIG. 7 shows an embodiment of the hold down brush, illustrating exemplary dimensions for the hold down brush.

FIG. 8 shows a perspective view of an embodiment of the hold down brush.

FIG. 9 shows a front view of an embodiment of the hold down brush.

FIG. 10 shows a bottom view of an embodiment of the hold down brush.

FIG. 11 shows a top view of an embodiment of the hold down brush.

FIG. 12 shows a side view of an embodiment of the hold down brush.

FIG. 13 shows another perspective view of an embodiment of the hold down brush with the tines in a flexed state.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of various aspects of the present invention. The scope of the present invention is not limited by this description.

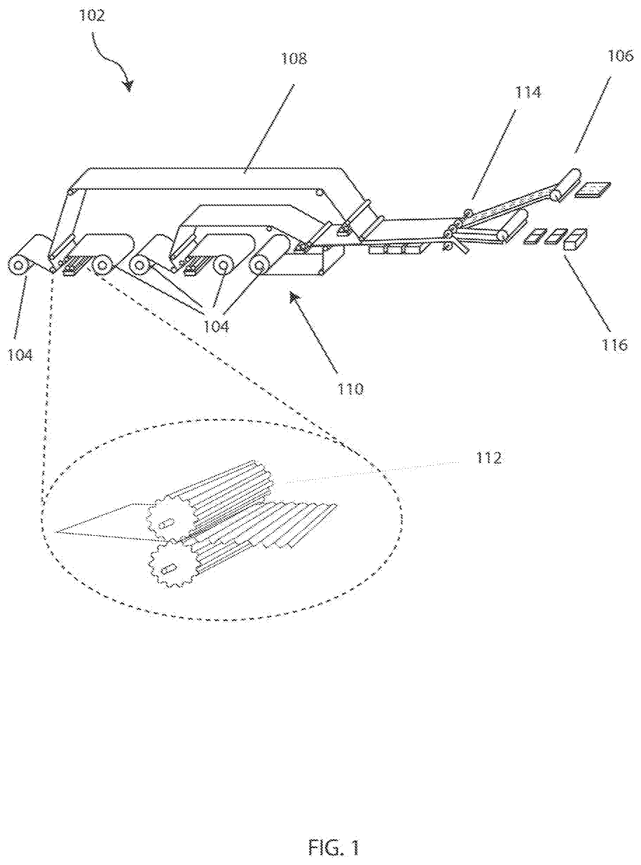

Referring to FIG. 1, embodiments relate to a hold down brush 100 configured to assist with maintaining alignment of product being conveyed through a processing machine 102. For instance, the hold down brush 100 can be configured for use in a corrugator machine 102. A corrugator machine 102 is an apparatus having rollers and conveyance tracks designed to assemble sheets of paper (with at least one of the sheets being corrugated) to generate a corrugated paper sheet (e.g., a corrugated cardboard sheet used to make a cardboard box). In some embodiments, the corrugator machine 102 can create the corrugated paper sheet that will form part of the corrugated sheet assemblage. For example, the corrugator machine 102 can include multiple inlets 104, a conveyance system 110, and an outlet end 106. The inlets 104 can be configured to introduce paper sheets 108 into the conveyance system 110 at different portions of the conveyance system 110 so to allow the corrugator machine 102 to assemble the paper sheets 108 at different stages of the process. The conveyance system 110 can include a corrugator roll assembly 112 to form a corrugation into a paper sheet 108 before the corrugated sheet 108 is assembled as part of the end product. The assembly of two different paper sheets 108 can be achieved via an application of adhesive to a paper sheet 108 and then directing the paper sheets 108 through two-adjacent rollers to allow pressure to cause the two paper sheets 108 to adhere to each other. The corrugator machine 102 will also include controllers, switches, sensors, etc. to assist with the proper operation thereof.

As a non-limiting example, a corrugation process can involve feeding a first paper sheet 108 into the corrugator machine 102 at a first inlet 104 and a second paper sheet 108 into the corrugator machine 102 at a second inlet 104. The second paper sheet 108 can be directed through the corrugator roll assembly 112 to generate a corrugation to the second paper sheet 108. Adhesive can be applied to the first paper sheet 108 and/or the second paper sheet 108. The first paper sheet 108 and the second paper sheet 108 can then be directed through two-adjacent rollers to allow pressure to cause the first paper sheet 108 and the second paper sheet 108 to adhere to each other. A third paper sheet 108 can be fed into the corrugator machine 102 at a third inlet 104. Adhesive can be applied to the combined first-second paper sheet 108 and/or the third paper sheet 108. The combined first-second paper sheet 108 and the third paper sheet 108 can then be directed through two-adjacent rollers to allow pressure to cause the combined first-second paper sheet 108 and the third paper sheet 108 to adhere to each other. The combined first-second-third paper sheet 108 can then be directed to a cutting apparatus 114 to cut the sheets 108 to a desired size.

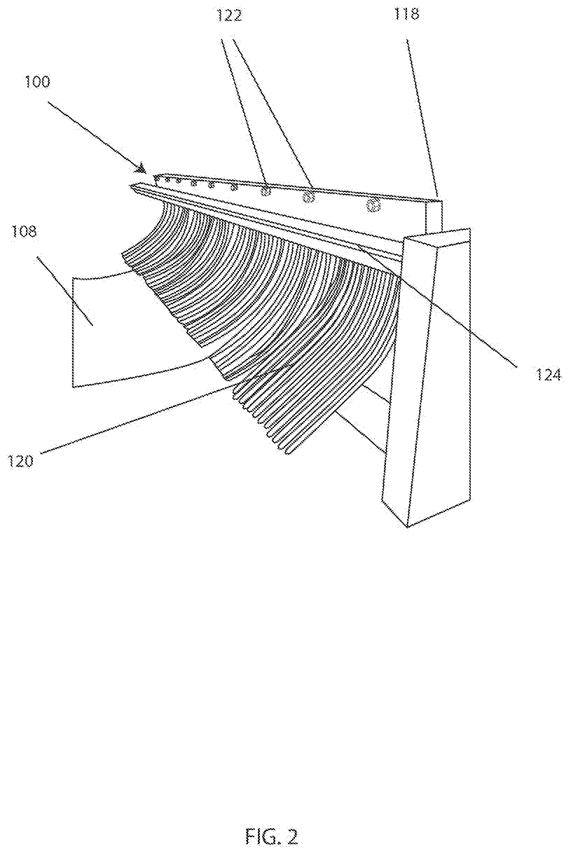

Referring to FIGS. 2-7, it is typically desired for the paper sheets 108 to be “held down” (e.g., guided, steered, held in place, aligned, prevented from being askew, prevented from buckling, prevent the combined sheets from mis-aligning with each other, etc.) as the sheets 108 are conveyed through the conveyance system 110. For instance, as the paper sheet 108 is caused to traverse the conveyance path, the orientation of the paper sheet 108 should be in-line with the direction of the conveyance path and the paper sheet 108 should not buckle, lift from a conveyor belt, etc. This can be achieved via a hold down brush 100. The hold down brush 100 can be positioned at points of transition (e.g., from one elevation to another), where rollers are located, at the cutting apparatus 114, at a staging stage 116, etc. Although it may be beneficial to position the hold down brushes 100 at transition points, it should be noted that hold down brush 100 can be positioned at any point or multiple points along the conveyance system 110.

Embodiment of the hold down brush 100 can include a base 118 and a plurality of tines 120 (may be referred to as fingers) extending from the base 118. The tines 120 in combination with the base 118 may resemble a brush; hence the term “brush”. The base 118 can be a rectangular member from which a plurality of tines 120 extending therefrom. The base 118 can include a coupling mechanism 122 (e.g., fasteners, aperture, threaded apertures, etc.) to facilitate removably attaching the hold down brush 100 to a support portion 124 (e.g., a carriage, a hanger, a rafter, a beam, a joist, etc.) of the corrugator machine 102. The support portion 124 can be positioned over a conveyance path such that the tines 120 extend from the base 118 and are able to make contact with the paper sheet 108. In some embodiments, the position of support portion 124 and/or the conveyor belt can be moved to selectively allow the tines 120 to make contact or not make contact with the paper sheet 108 as the paper sheet 108 is being traversed through the corrugator machine 102.

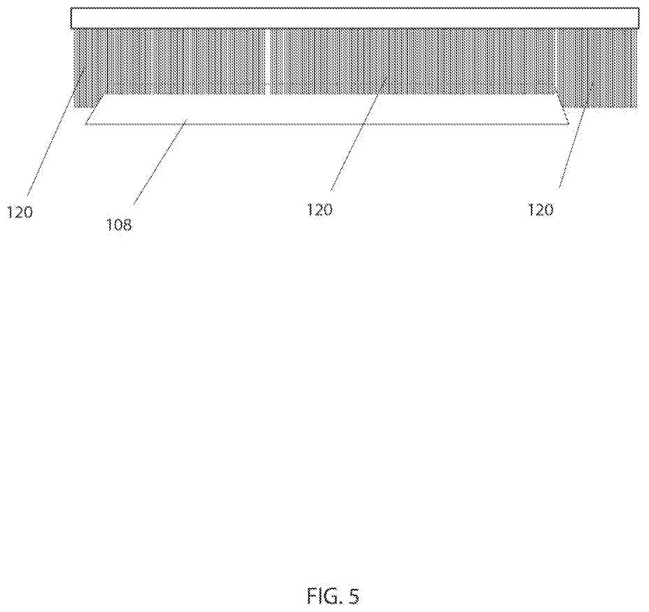

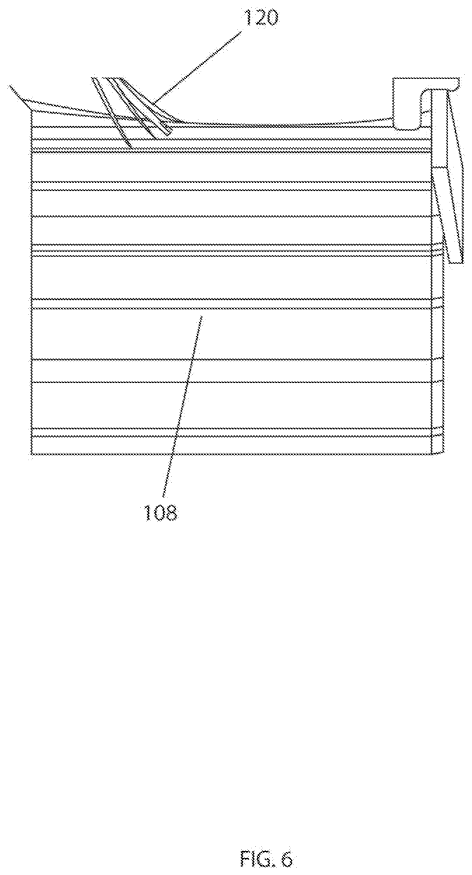

When the tines 120 make contact with the paper sheet 108, the tines 120 bend or flex. The flexure of the tines 120 applies pressure to the paper sheet 108 to achieve the hold down. The base 118 can be wider than the width of the paper sheet 108 so that tines 120 located at distal ends of the base 118 can extend over the sides of the paper sheet 108 and/or the conveyor belt. The tines 120 that extend over the paper sheet 108 (e.g., the overextending tines 120) can provide a guide barrier to prevent the paper sheet 108 from shifting laterally. (See FIGS. 5-6). In addition, when the paper sheet 108 is cut to size, the cut sheets 108 may be stacked at a staging stage 116. The overextending tines 120 can further serve as a guide barrier to cause each cut sheet 108 to stack on the previously cut sheet 108 in an orderly and aligned fashion.

It should be noted that while embodiments of the hold down brush 100 are described and illustrated for use with a corrugator machine 102, it is understood that the hold down brush 100 can be used for any type of processing machine or conveyance system in which maintaining proper alignment of product being conveyed is desired.

As noted herein, conventional hold down brushes are limited in that they use tines that are not food-grade material, the tines tend to break due to fatigue or other material degradation, the tines tend to dislodge from the brush, and the brushes include base portions that are too large to facilitate quick and easy replacement and maintenance. Embodiments of the inventive hold down brush 100, however, are designed to overcome these deficiencies.

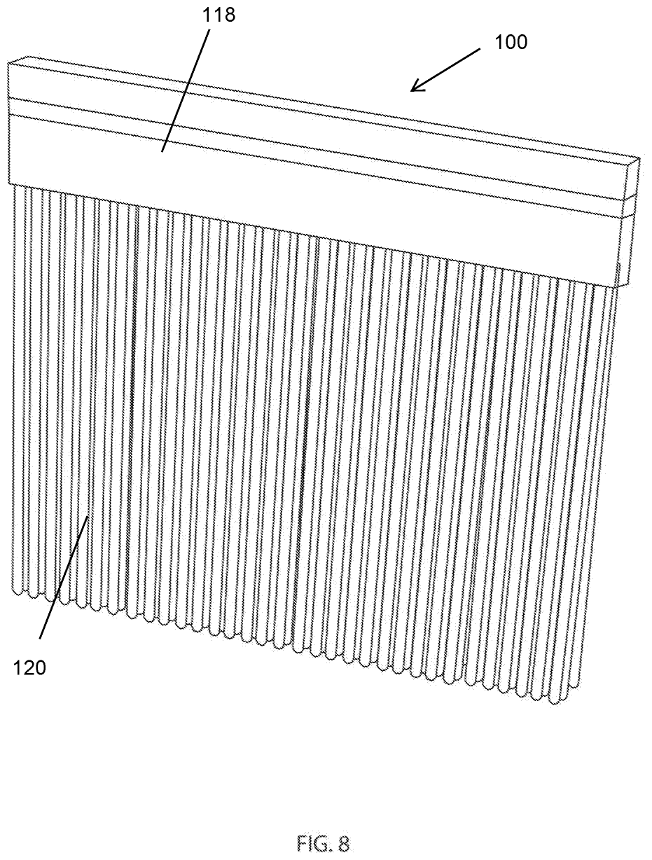

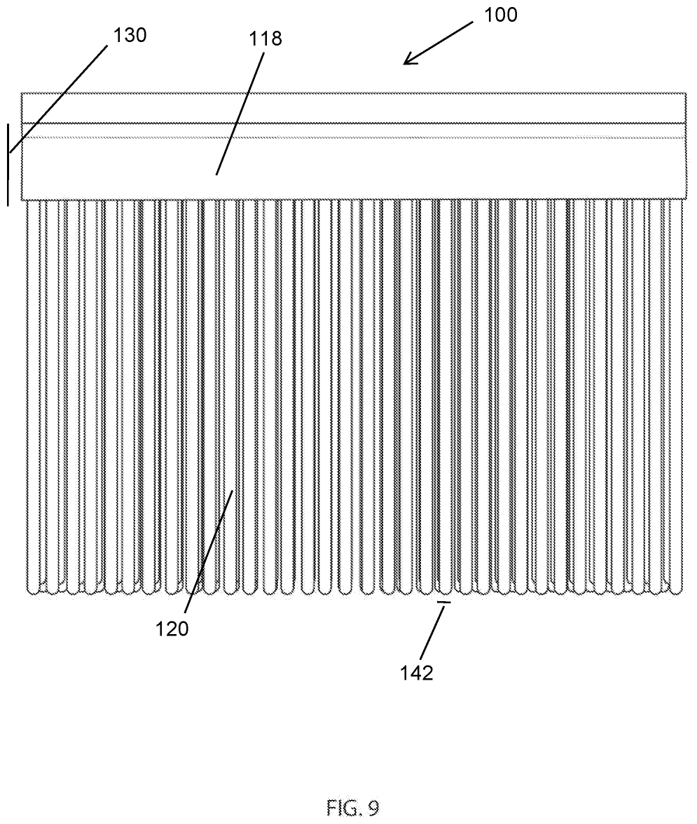

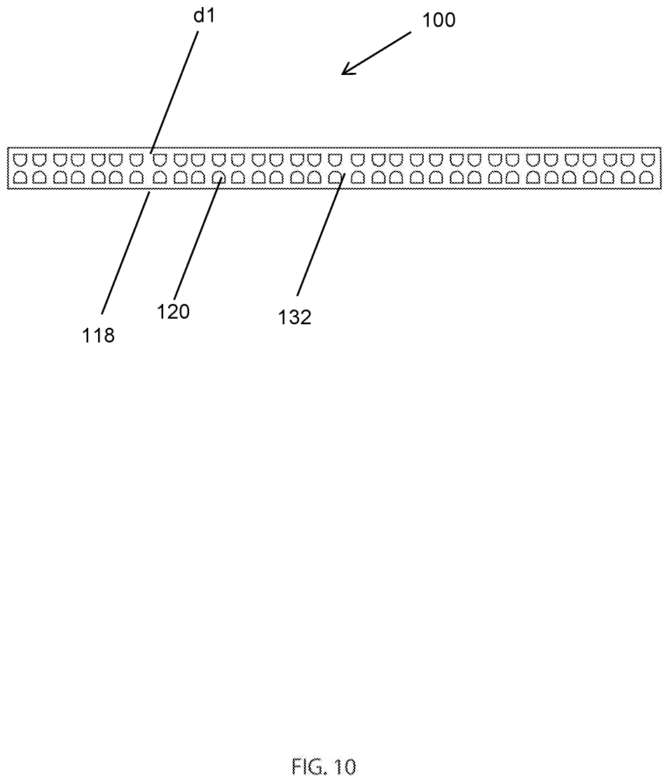

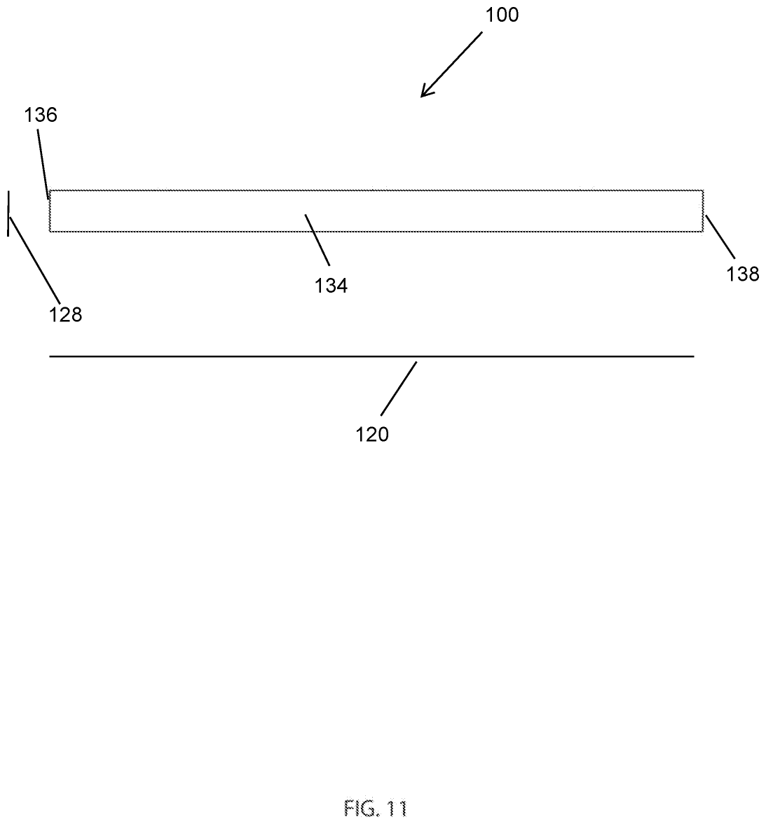

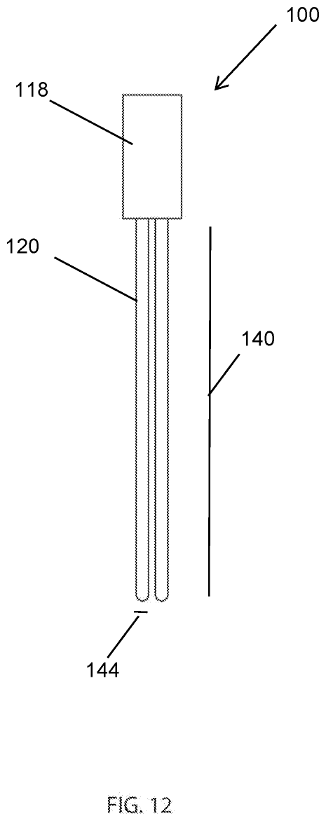

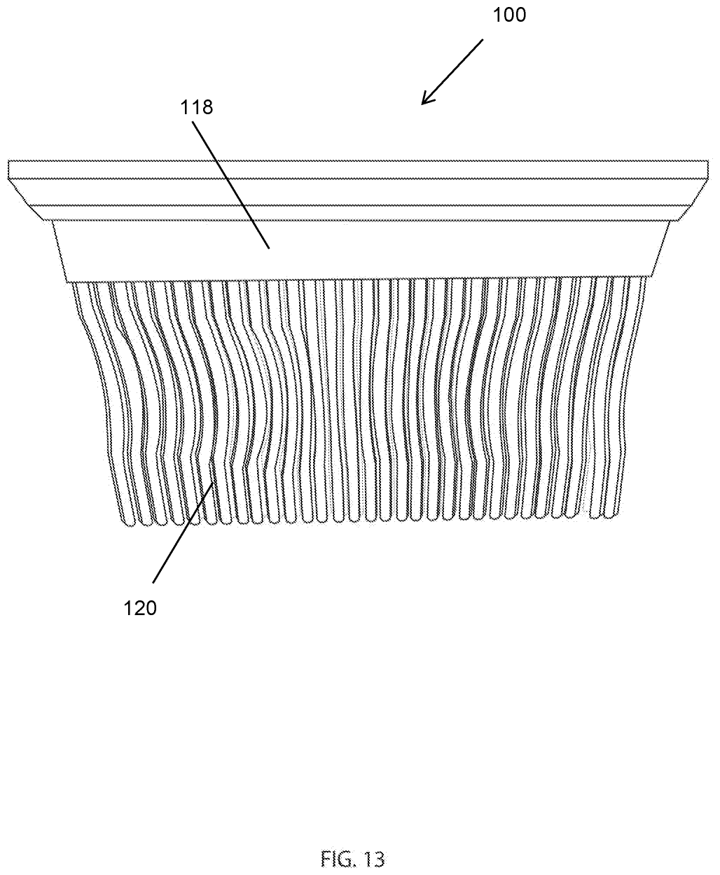

Referring to FIGS. 8-13, the hold down brush 100 includes a base 118 and a plurality of tines 120 extending from the base 118. It is contemplated for the base 118 to be made from a polymer material (e.g., polyurethane), but the base 118 can be made from other materials. The base 118 can be rectangular in shape. For instance, the base 118 can have a width 126, a thickness 128, and a height 130. The width 126 of the base 118 is contemplated to be less than a width of a paper sheet 108 so that a plurality of hold down brushes 100 can be attached to the support portion 124, wherein the plurality of hold down brushes 100 are used in place of a conventional unitary hold down brush that would be wider than the width of the paper sheet 108. For instance, the inventive hold down brush 100 can be used by attaching a first hold down brush 100 to the support portion 124, attaching a second hold down brush 100 to the support portion 124 so that the second hold down brush 100 is adjacent the first hold down brush 100, and attaching a third hold down brush 100 to the support portion 124 so that the third hold down brush 100 is adjacent the second hold down brush 100. A distal end of the first hold down brush 100 and a distal end of the third hold down brush 100 can be designated as portion of the brushes 100 that will have overextending tines 120 (if it is desired to have overextending tines 120)—i.e., the entire width of the series of hold down brushes 100 may be as wider than the paper sheet 108 and/or the conveyor belt. Some uses of the inventive hold down brush 100 may not require overextending tines 120 and so the entire width of the series of hold down brushes 100 may be as wide or less wide as the paper sheet 108.

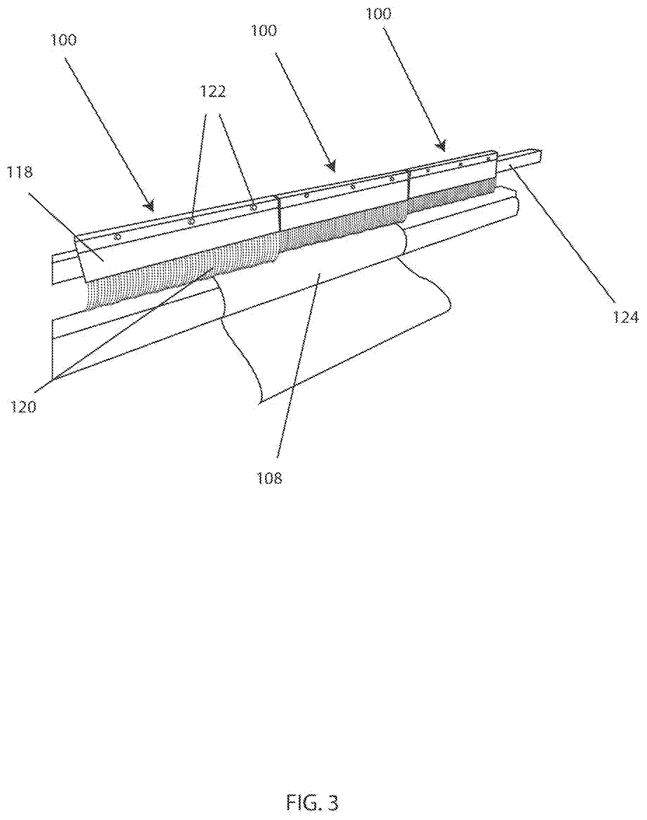

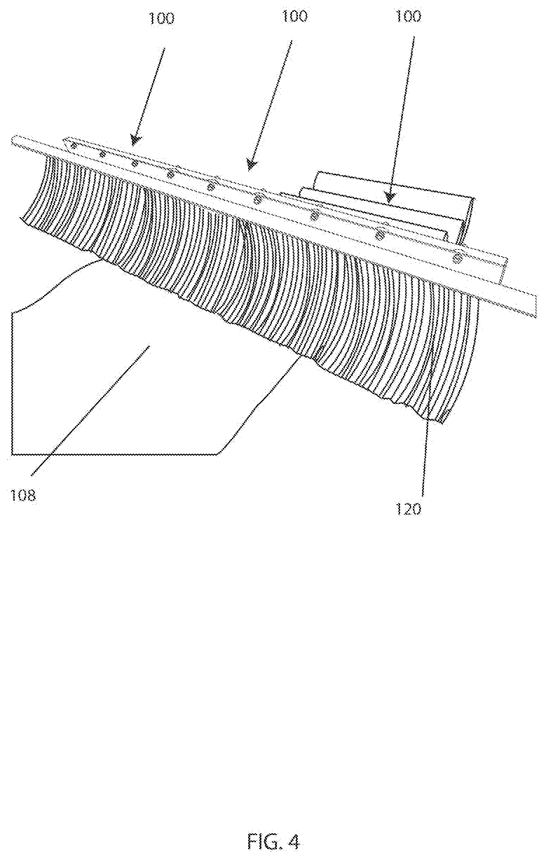

In other words, the hold down brush 100 used in a corrugator machine 102 can include a plurality of segments of individual hold down brushes 100. (See FIGS. 3-4). It is contemplated for each individual hold down brush to be 11 inches in width, but the width can change based on the width of the paper sheet 108 and other design criteria. Use of individual hold down brush segments to form the hold down brush 100 used in a corrugator machine 102 can facilitate quick and easy removal, replacement, adjustment, etc. of a segment of the hold down brush 100 for maintenance purposes. This is not possible with conventional hold down brushes, as they are configured to be a unitary member.

It should be understood that more or less hold down brush segments 100 can be used. In addition, the size, shape, and configuration of one hold down brush segment 100 can be the same or different from the size shape, and configuration of another hold down brush segment 100.

As noted herein, the base 118 is contemplated to be rectangular. Thus, the base 118 can have a base first side 132, a base second side 134, a base third side 136, and a base fourth side 138, wherein the base first side 132 subtends the base second side 134, and wherein the base third side 136 subtends the base fourth side 138. The first and second sides 132, 134 can be the long sides whereas the third and fourth sides 136, 138 can be the short sides. The tines 120 can extend from the first side 132, for example, and the coupling mechanism 122 can be attached or formed in/on the second side 134, for example. As noted herein, the base 118 can be made from a polymer. The base 118 can be made in a mold and the tines 120 can be inserted into the mold so that the tines 120 are held in place by the hardening or curing of the polymer material when the base 118 is being formed. The tines 120 being secured in this fashion is an improvement over conventional methods that glue the tines in place. The use of glue tends to allow the tines to become dislodged when the conventional hold down brush is used in practice. The inventive hold down brush 100, however, with the tines 120 secured via molding them in place reduces or eliminates the dislodging of the tines 120 when used in practice.

The tines 120 are made from acetyl (e.g., KEPITAL F10-02 Natural, F10-01 Natural, F10-01 BK, F10-01 BBK, etc.). Conventional tines are made from steel or plastic, which are not food-grade and tend to break due to fatigue or by other material degradation. Tines 120 made from acetyl are more durable, reducing or eliminating the occurrence of pieces breaking off. Tines 120 made from acetyl are also food-grade (approved by the U.S. Food and Drug Administration) so that if a piece of tine 120 does break off or some acetyl does wear off, it is considered not to be harmful.

The hold down brushes 100 can include a plurality of tines 120 extending from the first side 132 so as to form a row of tines 120. Some embodiments can include a plurality of rows of tines 120. For instance, the hold down brush 100 can include a first row of tines 120 having a first tine 120, a second tine 120 adjacent the first tine 120 but spaced apart from it by a distance d₁, a third tine 120 adjacent the second tine 120 but spaced apart from it by a distance d₁, etc. The d₁ between any two tines 120 of the first row can be the same or different from the d₁ between any two other tines 120 of the first row. The hold down brush 100 can include a second row of tines 120 having a first tine 120, a second tine 120 adjacent the first tine 120 but spaced apart from it by a distance d₁, a third tine 120 adjacent the second tine 120 but spaced apart from it by a distance d₁, etc. The d₁ between any two tines 120 of the second row can be the same or different from the d₁ between any two other tines 120 of the second row. The positioning and spacing of tines 120 of the first row can be the same as the positioning and spacing of tines 120 of the second row. For instance, the positioning and spacing of tines 120 of the first row and second row can be such that the tines 120 of the first row are not staggered (i.e., in-line with) the tines 120 of the second row. The positioning and spacing of tines 120 of the first row and second row can be such that the tines 120 of the first row are staggered (i.e., misaligned with) the tines 120 of the second row. More or less than two rows can be used. In addition, the number and shape of tines 120 of any row can be the same as or different from the number and shape of tines 120 in another row(s).

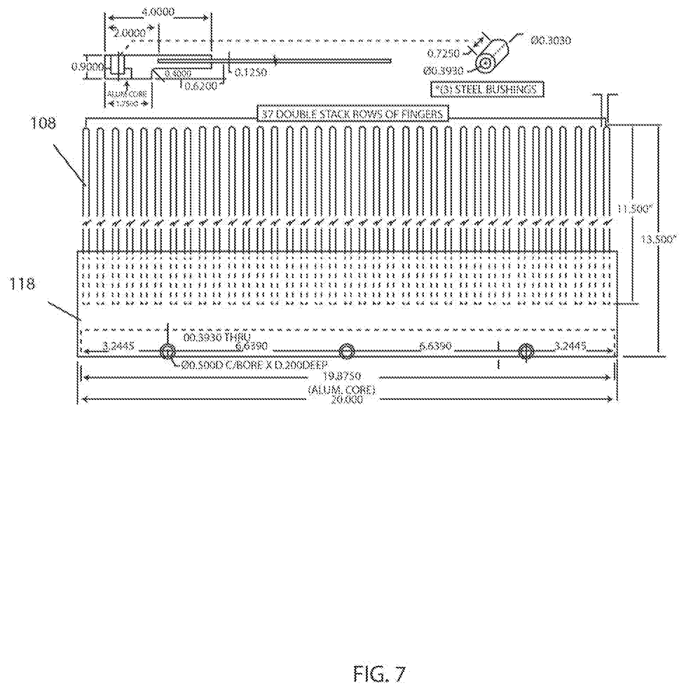

It is contemplated for the tines 120 to be rectangular in cross-section. However, other shapes can be used, such as square, triangular, circular, oval, hexagonal, etc. The tine 120 can have a length 140. Referring to FIG. 7, it is contemplated for the length 140 of each tine 120 to be 13.5 inches. As noted above, the tines 120 can be embedded so as to be molded within the base 118, and thus a portion of the 13.5-inch tine 120 can extend within the base 118. It is contemplated for a 2-inch portion of the 13.5-inch tine 120 to be embedded within the base 118, thereby forming an 11.5-inch tine 120 extending from the edge of the base 118. The tine 120 can have a thickness 142 and a width 144. The thickness 142 can be ¼ inches and the width 144 can be ⅛ inches. It should be noted that the dimensions provided above are exemplary only, and that other dimensions can be used based on design criteria and intended use. The dimensions (cross-sectional shape, length 140, width 144, thickness 142, etc.) of one tine 120 can be the same or different from the cross-sectional shape of another tine(s) 120.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of systems, devices, and methods of making and using the same have been discussed and illustrated herein, it is to be distinctly understood that the invention is not limited thereto but may be otherwise variously embodied and practiced within the scope of the following claims.

What is claimed is:

1. A hold down brush, comprising:
a base having a first side and a second side;
a plurality of tines extending from the first side; and
a coupling mechanism disposed in or on the base at or near the second side, the coupling mechanism configured to attach the hold down brush to a support portion of a corrugator machine.

2. The hold down brush recited in claim 1, wherein the base is polyurethane.

3. The hold down brush recited in claim 1, wherein each tine is acetyl.

4. The hold down brush recited in claim 1, wherein the base is formed by a molding process and each tine is embedded in the base during the molding process.

5. The hold down brush recited in claim 1, wherein the plurality of tine comprises a first row of tines and a second row of tines.

6. The hold down brush recited in claim 5, wherein the tines of the first row are not staggered with respect to the tines of the second row.

7. The hold down brush recited in claim 5, wherein the tines of the first row are staggered with respect to the tines of the second row.

8. The hold down brush recited in claim 1, wherein the base has a width that is less than a width of a conveyor of the corrugator machine.

9. A method of using hold down brush for a corrugator machine, the method comprising:
attaching a first hold down brush to a support portion of the corrugator machine; and
attaching a second hold down brush to the support portion of the corrugator machine so that the second hold down brush is adjacent the first hold down brush.

10. The method recited in claim 9, further comprising removing the first hold down brush and/or the second hold down brush for replacement or repair.

11. The method recited in claim 9, further comprising attaching a third hold down brush to the support portion of the corrugator machine so that the third hold down brush is adjacent the second hold down brush.

12. The method recited in claim 9, wherein a distal end of the first hold down brush and a distal end of the second hold down brush have tines that overextend product being conveyed via the corrugator machine.

13. The method recited in claim 11, wherein a distal end of the first hold down brush and a distal end of the third hold down brush have tines that overextend product being conveyed via the corrugator machine.

14. A method of making a hold down brush for a corrugator machine, the method comprising:
inserting a plurality of tines in a mold;
introducing a polymer into the mold; and
allowing the polymer to cure or harden to form a base and to embed the plurality of tines within the base.

15. The method recited in claim 14, wherein the plurality of tines comprises a first row of tines and a second row of tines.

16. The method recited in claim 15, further comprising staggering the tines of the first row with respect to the tines of the second row.

17. The method recited in claim 15, further comprising aligning the tines of the first row with respect to the tines of the second row.

18. The method recited in claim 14, wherein the polymer is polyurethane.

19. The method recited in claim 14, wherein each tine is acetyl.

20. The method recited in claim 14, further comprising disposing a coupling mechanism in or on the base.
